(19) United States
(12) Patent Application Publication
(10) Pub. No.: US 2025/0334427 A1
(43) Pub. Date: Oct. 30, 2025

(54) Measured Value Acquisition Device for an Inductive Sensor Arrangement

(71) Applicant: Robert Bosch GmbH, Stuttgart (DE)

(72) Inventor: Stefan Kuntz, Flein (DE)

(21) Appl. No.: 19/188,141

(22) Filed: Apr. 24, 2025

(30) Foreign Application Priority Data
Apr. 25, 2024 (DE) 10 2024 203 876.8

(51) Int. Cl. G01D 5/20

(52) U.S. Cl. CPC G01D 5/2053

(57) ABSTRACT

A measured value acquisition device for an inductive sensor arrangement for detecting a rotary movement includes a circuit carrier and a receiver structure which covers a circular ring and includes a receiving coil having at least two windings. A winding of the receiving coil has, in each case, two loop structures with periodically repeating loop sections and is formed in at least two planes of the circuit carrier. Sections of the loop structures arranged in different planes are electrically connected to each other via through-hole platings. The loop structures are arranged offset with respect to each other by a predetermined spacing angle and are each separated at at least one separation point, which is formed within the receiver structure at a design-dependent intersection point of the respective loop structures.

This application claims priority under 35 U.S.C. § 119 to patent application no. DE 10 2024 203 876.8, filed on Apr. 25, 2024 in Germany, the disclosure of which is incorporated herein by reference in its entirety.

The disclosure relates to a measured value acquisition device for an inductive sensor arrangement. The object of the disclosure is also an inductive sensor arrangement having at least one such measured value acquisition device.

### BACKGROUND

Inductive sensor arrangements are known from the prior art, which have a measured value acquisition device with at least one exciter structure and at least one receiver structure and at least one coupling device, which is also referred to as a target. The at least one exciter structure further comprises at least one exciter coil. The at least one coupling device comprises at least one electrically conductive coupling element. The at least one receiving structure comprises at least one, but usually two, receiving coils. A high frequency current passes through the at least one exciter coil generating an alternating magnetic field, which induces eddy currents in the at least one coupling device. In this context, the inductive coupling of the at least one exciter coil and the at least one receiving coil depends on the position of the corresponding coupling device. The induced voltage signal in the at least one receiver coil can be used to infer the current position of the coupling device and thus the current position of a body whose movement is to be detected.

An inductive angle sensor is known from DE 10 2020 206 396 A1, which comprises an inductive target arrangement with k-fold symmetry as well as a first pickup coil arrangement with k-fold symmetry and a second pickup coil arrangement with k-fold symmetry. A combination device is designed to combine signals of the first pickup coil arrangement with signals of the second pickup coil arrangement and determine an angle error compensated rotation angle based thereon. The pickup individual coils of the first and second pickup coil assemblies are each rotationally offset about the axis of rotation by a geometric offset angle relative to each other. Additionally, the entire first pickup coil arrangement is rotationally offset by a geometric offset angle relative to the entire second pickup coil arrangement about the axis of rotation. In one possible embodiment, the first and second pickup coil arrangements are galvanically coupled to each other and form one or more single pickup coil pairs, wherein, in each pick-p single coil pair, one of the pickup single coils of the first pickup coil arrangement is connected together in a series connection or parallel connection with one pickup single coil of the second pickup coil arrangement, which is offset by the geometric offset angle. The combining device is designed to determine the angle error compensated rotation angle between the stator and the rotor based on a combination of the signals of the respective interconnected pickup single coils of the one or more pickup single coil pairs.

A measured value acquisition device for an inductive sensor arrangement and an inductive sensor arrangement with at least one such measured value acquisition device are known from the applicant's DE 10 2022 211 560 A1, which has been published subsequently. The measured value acquisition device comprises a circuit carrier which covers a movement path of a coupling device with at least one electrically conductive coupling element. The coupling device is coupled to a movable body whose movement is to be detected. The circuit carrier comprises at least one receiving structure comprising at least one receiving coil with at least two windings electrically connected in series. A single winding of the at least one receiving coil has two loop structures with periodically repeating loop sections and extends over the path of movement of the coupling device and is formed in at least two planes of the circuit carrier. Portions of the individual loop structures arranged in different planes of the circuit carrier are electrically connected to each other via through-hole platings. The periodically repeating loop sections of the two loop structures of the individual windings have opposite flow direction. The loop structures of the at least two windings electrically connected in series of the at least one receiving coil are arranged offset with respect to each other by a predetermined distance in the direction of the movement path. Here, the individual loop structures of the at least two windings of the at least one receiving coil are separated at at least one separation point and connected to each other via at least one connecting structure such that an electrical series connection of the at least two windings is created. The at least one connecting structure comprises at least two connecting elements, which are arranged in at least two parallel planes and have opposite directions of passage. Since the at least one connecting structure for the electrical series connection of the at least two windings is arranged outside the receiver structure, additional installation space is required in the radial direction for the at least two connecting elements of the at least one connecting structure.

A measured value acquisition device for an inductive sensor arrangement and an inductive sensor arrangement with at least one such measured value acquisition device are known from the applicant's DE 10 2024 200 845 A1, which has been published subsequently. The measured value acquisition device comprises a circuit carrier which comprises at least one receiver structure. The at least one receiving structure comprises at least one receiving coil having at least two windings. A single winding of the at least one receiving coil has in each case two loop structures with a plurality of loop sections and is formed in at least two planes of the circuit carrier. Portions of the individual loop structures arranged in different planes of the circuit carrier are electrically connected to each other via through-hole platings. The loop sections of the two loop structures of the individual windings have opposite flow directions. In addition, the loop structures of the at least two windings electrically connected in series of the at least one receiving coil are arranged offset with respect to one another by a predetermined distance. In this case, ends of the individual loop structures of the at least two windings of the at least one receiving coil are each connected to each other at end regions of the corresponding receiving structure via at least one connecting structure such that an electrical series connection of at least two windings and/or a reversal of a flow direction is created within one of the at least two windings.

### SUMMARY

The measured value acquisition device for an inductive sensor arrangement, as disclosed herein, and the inductive sensor arrangement, as disclosed herein, each have the advantage that by separating loop structures, arranged in different planes, of two windings of a receiver coil at design-dependent intersection point and connecting the ends of the separated loop structures in pairs via corresponding connecting structures within the receiver structure, an electrical series connection of two windings of the receiver coil is realized and the amplitude of a voltage induced in the receiver coil is increased and at the same time an angle error of the measured value acquisition device or the inductive sensor arrangement is reduced. of the inductive sensor arrangement can be reduced. By placing the at least one separation point and the connecting structures inside the receiver structure, no additional space or installation space is required outside the receiver structure. A higher induced voltage results in a better signal-to-noise ratio and increased EMC robustness (EMC: electromagnetic compatibility). Furthermore, this enables the use of more cost-effective semiconductor amplifiers with lower amplification factors.

Embodiments of the disclosure provide a measured value acquisition device for an inductive sensor arrangement for detecting a rotary movement, having a circuit carrier and at least one receiver structure arranged on the circuit carrier, which covers a circular ring and comprises at least one receiving coil having at least two windings. A single winding of the at least one receiving coil has in each case two loop structures with periodically repeating loop sections and is formed in at least two planes of the circuit carrier. Portions of the individual loop structures arranged in different planes of the circuit carrier are electrically connected to each other via through-hole platings. In this case, the loop structures of the at least two windings of the at least one receiving coil are arranged offset with respect to each other by a predetermined spacing angle and are each separated at at least one separation point, which is formed within the at least one receiver structure in each case at a design-dependent intersection point of the respective loop structures arranged in different planes. At at least one first separation point, two loop structures of two different windings of the at least one receiving coil are separated and ends of the two separated loop structures are connected to each other in pairs via a respective connecting structure such that the two windings are electrically connected in series.

The term “within the receiver structure” is understood here to mean that the separation points and the connecting structures are arranged within the area covered by the receiver structure. In embodiments of the disclosure, the receiver structure covers a closed circular ring with an inner radius r_i and a larger outer radius r_a. This means that the at least one separation point and the two connecting structures for connecting the ends of the separated loop structures are arranged within the closed circular ring. Furthermore, the loop structures of the two windings of the at least one receiving coil to be connected are not terminated at the corresponding separation point, but only separated, so that the ends of the separated loop structure of the first winding can be connected in pairs to ends of the separated loop structure of the second winding via the connecting structures.

In addition, an inductive sensor arrangement for detecting a rotary movement of a movable body, with at least one movable coupling device which is coupled to the movable body, and such a measured value acquisition device is proposed. At least one exciter structure is arranged on a circuit carrier of the measured value acquisition device. The at least one exciter structure is coupled to an evaluation and control unit, which is designed to couple a periodic alternating signal into the at least one exciter structure during operation. The at least one movable coupling device is designed to influence an inductive coupling between the at least one exciter structure and at least one receiving structure of the measured value acquisition device. The at least one evaluation and control unit is further designed to receive and evaluate signals induced in the at least one receiver structure and to determine a current position of the movable body.

In the following, the at least one exciter structure can be understood as an exciter coil with a predetermined number of turns, which emits the alternating signal coupled in by the evaluation and control unit. The exciter coil can enclose the receiver structure on the outside and/or inside. This means that the windings of the exciter coil can be arranged either outside the outer radius r_a of the annular surface covered by the receiver structure or inside the inner radius r_i of the annular surface covered by the receiver structure. As a further alternative, windings of the exciter coil can be arranged both outside the outer radius r_a of the annular surface covered by the receiver structure and inside the inner radius r_i of the annular surface covered by the receiver structure. At least partial overlapping of the exciter structure and the receiver structure in different positions or planes of the circuit carrier is also possible.

The inductive sensor arrangement can, for example, be designed as a rotary angle sensor or rotor position sensor, in which the movable body performs the rotary movement to be detected around an axis of rotation. The at least one coupling device comprises at least one electrically conductive coupling element. A high-frequency current coupled by the evaluation and control unit flows through the at least one exciter coil, generating an alternating magnetic field which induces eddy currents in the at least one coupling device. In this context, the inductive coupling of the at least one exciter coil and the at least one receiving coil depends on the angle position of the corresponding coupling device. The evaluation and control unit can use the induced voltage signal in the at least one receiving coil to infer the electrical angle of rotation of the coupling device and the current angle of rotation of the shaft or rotor.

In the present case, an evaluation and control unit can be understood as an electrical assembly or electrical circuit that prepares, processes or evaluates recorded sensor signals. Preferably, the evaluation and control unit can be designed as an ASIC component (ASIC: application-specific integrated circuit). The evaluation and control unit can comprise at least one interface, which can be implemented as hardware and/or software. When implemented as hardware, the interfaces can be part of the ASIC component, for example. However, it is also possible that the interfaces are dedicated integrated circuits or consist at least partly of discrete components. When implemented as software, the interfaces can be software modules present, for example, on a microcontroller alongside other software modules.

Advantageous improvements to the measured value acquisition device for an inductive sensor arrangement and the inductive sensor arrangement are possible by means of the measures and further embodiments specified herein.

It is particularly advantageous that two loop structures of the same winding of the at least one receiving coil can be separated at at least one second separation point and ends of the two separated loop structures can be connected to each other in pairs via a respective connecting structure such that a respective first loop structure is connected to a respective second loop structure of the same winding. As a result, two reversal points can be realized in this winding, at which a flow direction is reversed. If the flow direction runs clockwise upstream of the connecting structure, then it runs counterclockwise downstream of the connecting structure and vice versa.

In an advantageous embodiment of the measured value acquisition device, the corresponding loop structures can have opposite flow directions at the design-dependent intersection points at which the at least one separation point is formed. In this case, the at least one connecting structure can, for example, connect a first loop structure of one of the two windings, which has a first flow direction, to a second loop structure of another of the two windings, which has a second flow direction opposite to the first flow direction. As a result, for example, the first loop structure of the first winding can be electrically connected to the second loop structure of the second winding via a first connecting structure, and the second loop structure of the first winding can be electrically connected to the first loop structure of the second winding via a second connecting structure. Here too, the flow direction changes at the connecting structure. If the flow direction runs clockwise upstream of the connecting structure, then it runs counterclockwise downstream of the connecting structure and vice versa.

In a further advantageous embodiment of the measured value acquisition device, a number of the separation points can be based on a number of the windings of the at least one receiving coil to be electrically connected in series. Preferably, the number of separation points or connection structure pairs of the at least one receiving coil can be calculated according to equation (G1).

$$N = ( 2 * nw ) - 1 \qquad ( G1 )$$

Here, N corresponds to the number of separation points and nw to the number of windings of the at least one receiving coil.

In a further advantageous embodiment of the measured value acquisition device, at least two first separation points, at each of which two loop structures of two different windings are separated, can be arranged radially spaced from each other on a common center line. Windings of the receiving coil not affected by the separation can continue to run above and/or below the separation points without interruption. This embodiment can be used in an advantageous manner, particularly with a small number of periods of the receiver structure, in order to arrange the separation points in a space-saving manner.

In a further advantageous embodiment of the measured value acquisition device, the at least one connecting structure may comprise at least one through-hole plating. In addition, the at least one connecting structure may comprise at least one connecting element which connects the corresponding end of the separated loop structure to the through-hole plating. As a rule, a protruding edge of a through-hole plating is sufficient to electrically connect the separated loop structure to the corresponding through-hole plating. In order to allow sufficient spacing between the connecting structures designed as through-hole platings, correspondingly short connecting elements can be used to electrically connect the separated loop structure to the corresponding through-hole plating. This allows the positions of the pairs of vias to be shifted slightly in order to avoid a short circuit or design rule violations. A design rule violation can be understood to mean, for example, falling below a minimum distance between the two through-hole platings of the through-hole plating pair or falling below a minimum distance between one of the two through-hole platings and adjacent conductor tracks.

In a further advantageous embodiment of the measured value acquisition device, the periodically repeating loop sections of the two loop structures can each correspond to a complete period of a sine wave or a rectangular wave or a triangular wave or a mixed form. A number of the periodically repeating loop sections SA can in this case define a periodicity of the at least one receiver structure.

An exemplary embodiment of the disclosure is shown in the drawings and is explained in more detail in the following description. Exemplary embodiments of the disclosure are illustrated in the drawings and explained in more detail in the following description. In the drawings, identical reference numerals refer to components or elements performing identical or similar functions.

### BRIEF DESCRIPTION OF THE DRAWINGS

FIG. 1 shows a schematic plan view of a first exemplary embodiment of an inductive sensor arrangement according to the disclosure with a first exemplary embodiment of a measured value acquisition device according to the disclosure, wherein a circuit carrier of the measured value acquisition device and a coupling device are shown transparently.

FIG. 2 shows a schematic plan view of a first alternative exemplary embodiment of a receiving coil for the measured value acquisition device according to the disclosure of FIG. 1 without a circuit carrier.

FIG. 3 shows a detailed representation III from FIG. 2.

FIG. 4 shows a schematic plan view of a second alternative exemplary embodiment of a receiving coil for the measured value acquisition device according to the disclosure shown in FIG. 1 without a circuit carrier.

### DETAILED DESCRIPTION

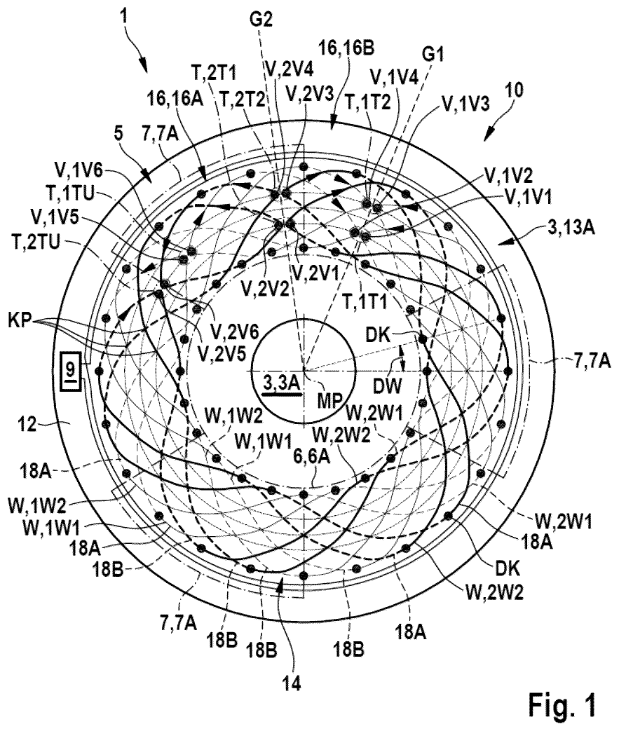

As can be seen from FIGS. 1 to 4, the illustrated exemplary embodiment of a measured value acquisition device 10 according to the disclosure for an inductive sensor arrangement 1 for detecting a rotary movement comprises a circuit carrier 12 and at least one receiver structure 14 arranged on the circuit carrier 12, which covers a circular ring and comprises at least one receiving coil 16 having at least two windings W. A single winding W of the at least one receiving coil 16 has in each case two loop structures 18A, 18B with periodically repeating loop sections and is formed in at least two planes of the circuit carrier 12. Sections of the individual loop structures 18A, 18B arranged in different planes of the circuit carrier 12 are electrically connected to each other via through-hole platings DK. The loop structures 18A, 18B of the at least two windings W of the at least one receiving coil 16 are arranged offset with respect to each other by a predetermined spacing angle DW and are each separated at at least one separation point T, which is formed within the at least one receiver structure 14 in each case at a design-dependent intersection point K P of the respective loop structures 18A, 18B arranged in different planes. Here, two loop structures 18A, 18B of two different windings W of the at least one receiving coil 16 are separated at at least one first separation point T1, T2, T3, T4, 1T1, 1T2, 2T1, 2T2 and ends of the two separated loop structures 18A, 18B are connected to each other in pairs via a respective connecting structure V such that the two windings W are electrically connected in series.

As can be further seen from FIGS. 1 to 4, two loop structures 18A, 18B of the same winding W of the at least one receiving coil 16 are separated at at least one second separation point 1TU, 2TU and ends of the two separated loop structures 18A, 18B are connected to each other in pairs via a respective connecting structure V such that a respective first loop structure 18A is connected to a respective second loop structure 18B of the same winding W.

The illustrated exemplary embodiment of the measured value acquisition device 10 according to the disclosure is used in an inductive sensor arrangement 1 designed as a rotary angle sensor or rotor position sensor, in which the movable body 3 is designed as a shaft 3A and performs a rotary movement to be detected about an axis of rotation. As a result, the spacing of the loop structures 18A, 18B of the at least two windings electrically connected in series W of the at least one receiving coil 16 corresponds to the predetermined spacing angle DW.

As can be further seen from FIG. 1, the illustrated exemplary embodiment of an inductive sensor arrangement 1 according to the disclosure for detecting a rotary movement of a movable body 3 comprises a movable coupling device 5, which is coupled to the movable body 3, and a measured value acquisition device 10 according to the disclosure. At least one exciter structure 13 is arranged on a circuit carrier 12 of the measured value acquisition device 10. The at least one exciter structure 13 is coupled to an evaluation and control unit 9, which is designed to couple a periodic alternating signal into the exciter structure 13 during operation. The movable coupling device 5 is designed to influence an inductive coupling between the exciter structure 13 and the receiver structure 14 of the measured value acquisition device 10. The at least one evaluation and control unit 9 is further designed to receive and evaluate signals induced in the receiver structure 14 and to determine a current position of the movable body 3. In the exemplary embodiment of the inductive sensor arrangement 1 shown, the exciter structure 13 has an exciter coil 13A, which is arranged radially outside the receiver structure 14 and encloses the receiver structure 14 on the outside.

As can also be seen from FIG. 1, the coupling device 5 shown in dashed lines comprises a base body 6 designed as a rotor 6A with three electrically conductive coupling segments 7 designed as wings 7A in the exemplary embodiment shown. The base body 6 of the coupling device 5 is connected to the shaft 3A in a rotationally fixed manner.

As can be further seen from FIG. 1, the receiver structure 14 of the measured value acquisition device 10A comprises two receiving coils 16, each with two windings 1W1, 1W2, 2W1, 2W2, which each have two loop structures 18A, 18B with three periodically repeating loop sections, so that the receiver structure 14 or the receiving coils 16 have a periodicity of three (p=3). The number nw of windings 1W1, 1W2, 2W1, 2W2 corresponds to the value 2. Here, the three periodically repeating loop sections of a first receiving coil 16A each correspond to a complete period of a sine wave. The three periodically repeating loop sections of a second receiving coil 16B each correspond to a complete period of a cosine curve. As can be further seen from FIG. 1, the sections of the individual loop structures 18A, 18B of the individual windings 1W1, 1W2, 2W1, 2W2 of the two receiving coils 16 arranged in different planes of the circuit carrier 12 each correspond to a half period of the repeating loop sections. The sections of the periodically repeating loop sections arranged in different layers of the circuit carrier 12 are electrically connected to each other via through-hole platings DK. The two loop structures 18A, 18B of the individual windings 1W1, 1W2, 2W1, 2W2 are arranged offset with respect to each other and have opposite flow directions. Due to the two loop structures 18A, 18B, which are arranged offset with respect to one another and have opposite flow directions, areas are enclosed between a first loop structure 18A and a second loop structure 18B of the individual windings 1W1, 1W2, 2W1, 2W2 of the receiving coils 16, in which magnetic fields with different orientations are induced. At the periodicity of p=3 of the receiving coils 16, three pairs of areas A1, A2 are enclosed between each of the two loop structures 18A, 18B of the two windings electrically connected in series 1W1, 1W2, 2W1, 2W2 of the two receiving coils 16.

The number N of separation points T of the individual receiving coils 16 is calculated according to equation (G1) and is based on the number nw of windings 1W1, 1W2, 2W1, 2W2 of the receiving coils 16. As can be further seen from FIG. 1, the first receiving coil 16A and the second receiving coil 16B each have three separation points T in the exemplary embodiment shown. In addition, the corresponding loop structures 18A, 18B have opposite flow directions at the design-dependent intersection points K P at which the separation points T are formed.

As shown in FIG. 1, the first receiving coil 16A has two first separation points 1T1, 1T2, at each of which the loop structures 18A, 18B of the two windings 1W1, 1W2 are separated, and the ends of the two separated loop structures 18A, 18B are connected to one another in pairs via a respective connecting structure 1V1, 1V2, 1V3, 1V4 such that the two windings 1W1, 1W2 of the first receiving coil 16A are electrically connected in series. In addition, the first receiving coil 16A has a second separation point 1TU, at which two loop structures 18A, 18B of the first winding 1W1 of the first receiving coil 16A are separated and ends of the two separated loop structures 18A, 18B are connected to each other in pairs via a respective connecting structure 1V5, 1V6 such that the first loop structure 18A is connected to the second loop structure 18B of the first winding 1W1 in each case. As a result, the connecting structures 1V5, 1V6 form two reversal points at the second separation point 1TU, at which the flow direction of the first winding 1W1 of the first receiving coil 16A changes. Starting from a first connecting structure 1V1 at a first separation point 1T1, the first loop structure 18A of the first winding 1W1 of the first receiving coil 16A is traversed in a clockwise direction up to a fifth connecting structure 1V5 at a second separation point 1TU. The fifth connecting structure 1V5 connects the first loop structure 18A of the first winding 1W1 to the second loop structure 18B of the first winding 1W1. As a result, the flow direction changes and the second loop structure 18B of the first winding 1W1 is traversed counterclockwise up to a third connecting structure 1V3 at a further first separation point 1T2. The third connecting structure 1V3 connects the second loop structure 18B of the first winding 1W1 to the first loop structure 18A of the second winding 1W2. As a result, the flow direction changes and the first loop structure 18A of the second winding 1W2 is traversed in a clockwise direction up to a fourth connecting structure 1V4 at the further first separation point 1T2. The fourth connecting structure 1V4 connects the first loop structure 18A of the second winding 1W2 to the second loop structure 18B of the first winding 1W1. As a result, the flow direction changes and the second loop structure 18B of the first winding 1W1 is traversed counterclockwise up to a sixth connecting structure 1V6 at the second separation point 1TU. The sixth connecting structure 1V6 connects the second loop structure 18B of the first winding 1W1 to the first loop structure 18A of the first winding 1W1. As a result, the flow direction changes and the first loop structure 18A of the first winding 1W1 is traversed in a clockwise direction up to a second connecting structure 1V2 at the first disconnection point 1T1. The second connecting structure 1V2 connects the first loop structure 18A of the first winding 1W1 to the second loop structure 18B of the second winding 1W2. As a result, the flow direction changes and the second loop structure 18B of the second winding 1W2 is traversed counterclockwise to the first connecting structure 1V1 at the first separation point 1T1. Thus, the two windings 1W1, 1W2 of the first receiving coil 16A are electrically connected in series.

Similarly, the second receiving coil 16B has two first separation points 2T1, 2T2, at each of which the loop structures 18A, 18B of the two windings 2W1, 2W2 are separated, and the ends of the two separated loop structures 18A, 18B are connected to each other in pairs via a respective connecting structure 2V1, 2V2, 2V3, 2V4 such that the two windings 2W1, 2W2 of the second receiving coil 16B are electrically connected in series. In addition, the second receiving coil 16B has a second separation point 2TU, at which two loop structures 18A, 18B of the second winding 2W2 of the second receiving coil 16B are separated and ends of the two separated loop structures 18A, 18B are connected to each other in pairs via a respective connecting structure 2V5, 2V6 such that the first loop structure 18A is connected to the second loop structure 18B of the second winding 2W2 in each case. As a result, the connecting structures 2V5, 2V6 form two reversal points at the second separation point 1TU, at which the flow direction of the second winding 2W2 of the second receiving coil 16B changes. Starting from a first connecting structure 2V1 at a first separation point 2T1, the first loop structure 18A of the second winding 2W2 of the second receiving coil 16B is passed clockwise to a fifth connecting structure 2V5 at a second separation point 2TU. The fifth connecting structure 2V5 connects the first loop structure 18A of the second winding 2W2 to the second loop structure 18B of the second winding 2W2. As a result, the flow direction changes and the second loop structure 18B of the second winding 2W2 is traversed counterclockwise up to a third connecting structure 2V3 at a further first separation point 2T2. The third connecting structure 2V3 connects the second loop structure 18B of the second winding 2W2 to the first loop structure 18A of the first winding 2W1. As a result, the flow direction changes and the first loop structure 18A of the first winding 2W1 is traversed in a clockwise direction up to a fourth connecting structure 2V4 at the further first separation point 2T2. The fourth connecting structure 2V4 connects the first loop structure 18A of the first winding 2W1 to the second loop structure 18B of the second winding 2W2. As a result, the flow direction changes and the second loop structure 18B of the second winding 2W2 is traversed counterclockwise up to a sixth connecting structure 2V6 at the second separation point 2TU. The sixth connecting structure 2V6 connects the second loop structure 18B of the second winding 2W2 to the first loop structure 18A of the second winding 2W2. As a result, the flow direction changes and the first loop structure 18A of the second winding 2W2 is traversed in a clockwise direction up to a second connecting structure 2V2 at the first separation point 2T1. The second connecting structure 2V2 connects the first loop structure 18A of the second winding 2W2 to the second loop structure 18B of the first winding 2W1. As a result, the flow direction changes and the second loop structure 18B of the first winding 2W1 is traversed counterclockwise to the first connecting structure 2V1 at the first separation point 2T1. Thus, the two windings 2W1, 2W2 of the second receiving coil 16B are electrically connected in series.

As can be further seen from FIG. 1, the two first separation points 1T1, 1T2 of the first receiving coil 16A, at each of which two loop structures 18A, 18B of two different windings 1W1, 1W2 are separated, are arranged radially spaced apart from each other on a first center line G1. At the same time, the first loop structures 18A of the two windings 2W1, 2W2 of the second receiving coil 16B cross each other at the first center line G1 above the two first separation points 1T1, 1T2. The second loop structures 18B of the two windings 2W1, 2W2 of the second receiving coil 16B cross each other at the first center line G1 below the two first separation points 1T1, 1T2. In addition, the two first separation points 2T1, 2T2 of the second receiving coil 16B, at each of which two loop structures 18A, 18B of two different windings 1W1, 1W2 are separated, are arranged radially spaced apart from one another on a second center line G2. At the same time, the first loop structures 18A of the two windings 1W1, 1W2 of the first receiving coil 16A cross each other at the second center line G2 above the two first separation points 2T1, 2T2. The second loop structures 18B of the two windings 1W1, 1W2 of the first receiving coil 16A cross each other at the second center line G2 below the two first separation points 2T1, 2T2.

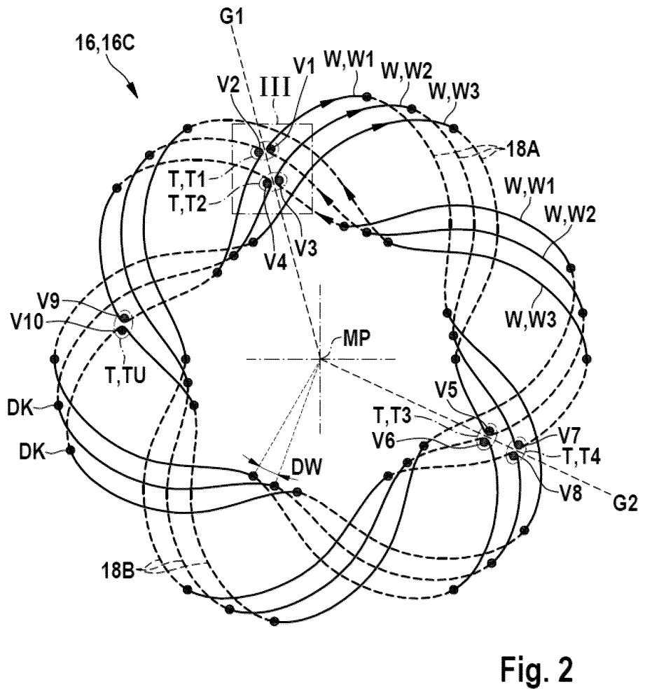

As can be further seen from FIGS. 2 to 4, the further exemplary embodiments shown of a receiving coil 16C, 16D for the measured value acquisition device 10 each comprise three windings W1, W2, W3, which each have two loop structures 18A, 18B with three periodically repeating loop sections, so that the receiving coils 16 have a periodicity of three (p=3). The number nw of the windings W1, W2, W3 corresponds to the value 3. The three periodically repeating loop sections of the receiving coils 16C, 16D each correspond to a complete period of a sine wave. As can be further seen from FIG. 1, the sections of the individual loop structures 18A, 18B of the individual windings W1, W2, W3 of the receiving coils 16C, 16D shown arranged in different planes of the circuit carrier 12 each correspond to a half period of the repeating loop sections. The sections of the periodically repeating loop sections arranged in different layers of the circuit carrier 12 are electrically connected to each other via through-hole platings DK. The two loop structures 18A, 18B of the individual windings W1, W2, W3 are arranged offset with respect to each other and have opposite flow directions. Due to the two loop structures 18A, 18B, which are arranged offset with respect to one another and have opposite flow directions, areas are enclosed between a first loop structure 18A and a second loop structure 18B of the individual windings W1, W2, W3 of the receiving coils 16, in which magnetic fields with different orientations are induced. At the periodicity of p=3 of the receiving coils 16C, 16D, three pairs of areas A1, A2 are enclosed between the two loop structures 18A, 18B of the two windings electrically connected in series W1, W2, W3 of the receiving coils 16C, 16D shown.

As can be further seen from FIGS. 2 to 4, the receiving coils 16C, 16D each have five separation points T in the exemplary embodiments shown. In addition, the corresponding loop structures 18A, 18B have opposite flow directions at the design-dependent intersection points K P at which the separation points T are formed.

As shown in FIGS. 2 to 4, the receiving coil 16C, 16D shown has four first separation points T1, T2, T3, T4, at each of which the loop structures 18A, 18B of two of the three windings W1, W2, W3 are separated, and the ends of the two separated loop structures 18A, 18B are connected to each other in pairs via a respective connecting structure V1, V2, V3, V4, V5, V6, V7, V8 such that the two corresponding windings W1, W2, W3 of the receiving coils 16C, 16D are electrically connected in series. In addition, the receiving coils 16C, 16D have a second separation point TU at which two loop structures 18A, 18B of the first winding W1 of the receiving coil 16 are separated and ends of the two separated loop structures 18A, 18B are connected to each other in pairs via a respective connecting structure V9, V10 such that the first loop structure 18A is connected to the second loop structure 18B of the first winding W1 in each case. As a result, the connecting structures V9, V10 at the second separation point TU form two reversal points at which the flow direction of the first winding W1 of the receiving coils 16C, 16D changes.

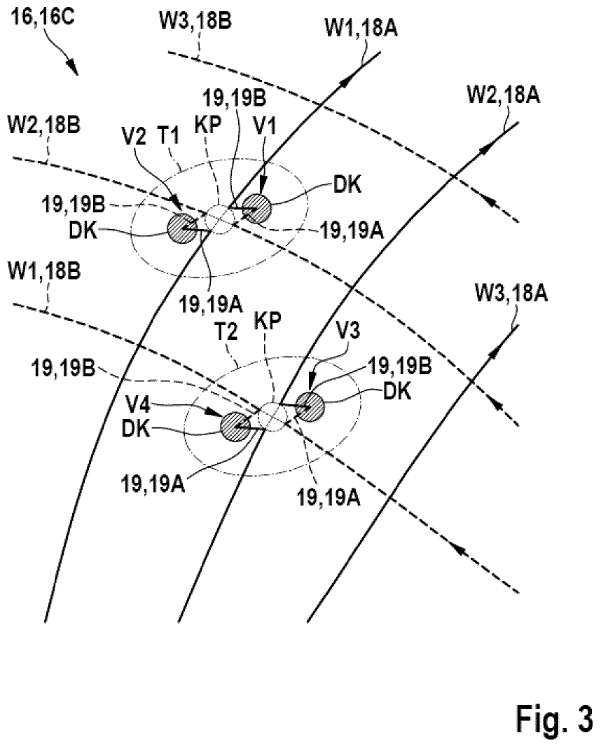

As can be further seen from FIGS. 2 and 3, a first separation point T1 and a second first separation point T2 of the receiving coil 16C, at which two loop structures 18A, 18B of the first winding W1 and the second winding W2 are respectively separated, are arranged radially spaced apart from one another on a first center line G1. At the same time, a second loop structure 18B of the third winding W3 crosses the first center line G1 above the two first separation points T1, T2 and a first loop structure 18A of the third winding W3 crosses the first center line G1 below the two first separation points T1, T2. In addition, a third first separation point T3 and a fourth first separation point T4 of the receiving coil 16C, at each of which two loop structures 18A, 18B of the second winding W2 and the third winding W3 are separated, are arranged radially spaced apart from one another on a common second center line G2. At the same time, a first loop structure 18A of the first winding W1 crosses the second center line G2 above the two first separation points T3, T4 and a second loop structure 18B of the first winding W1 crosses the second center line G2 below the two first separation points T1, T2.

Starting from a first connecting structure V1 at the first separation point T1, the first loop structure 18A of the first winding W1 of the receiving coil 16C is traversed in a clockwise direction up to a tenth connecting structure V10 at a second separation point TU. The tenth connecting structure V10 connects the first loop structure 18A of the first winding W1 to the second loop structure 18B of the first winding W1. As a result, the flow direction changes and the second loop structure 18B of the first winding W1 is traversed counterclockwise up to a third connecting structure V3 at the second first separation point T2. The third connecting structure V3 connects the second loop structure 18B of the first winding W1 to the first loop structure 18A of the second winding W2. As a result, the flow direction changes and the first loop structure 18A of the second winding W2 is traversed in a clockwise direction up to a seventh connecting structure V7 at the fourth first separation point T4. The seventh connecting structure V7 connects the first loop structure 18A of the second winding W2 to the second loop structure 18B of the third winding W3. As a result, the flow direction changes and the second loop structure 18B of the third winding W3 is traversed counterclockwise up to an eighth connecting structure V8 at the fourth first separation point T3. The eighth connecting structure V8 connects the second loop structure 18B of the third winding W3 to the first loop structure 18A of the second winding W2. As a result, the flow direction changes and the first loop structure 18A of the second winding W2 is traversed in a clockwise direction up to a fourth connecting structure V4 at the second first separation point T2. The fourth connecting structure V4 connects the first loop structure 18A of the second winding W2 to the second loop structure 18B of the first winding W1. As a result, the flow direction changes and the second loop structure 18B of the first winding W1 is traversed counterclockwise up to the ninth connecting structure V9 at the second separation point TU. The ninth connecting structure V9 connects the second loop structure 18B of the first winding W1 to the first loop structure 18A of the first winding W1. As a result, the flow direction changes and the first loop structure 18A of the first winding W1 is traversed clockwise up to the second connecting structure V2 at the first separation point T1. The second connecting structure V2 connects the first loop structure 18A of the first winding W1 to the second loop structure 18B of the second winding W2. As a result, the flow direction changes and the second loop structure 18B of the second winding W2 is traversed counterclockwise up to the sixth connecting structure V6 at a third first separation point T3. The sixth connecting structure V6 connects the second loop structure 18B of the second winding W2 to the first loop structure 18A of the third winding W3. As a result, the flow direction changes and the first loop structure 18A of the third winding W3 is traversed in a clockwise direction up to the fifth connecting structure V5 at the third first separation point T3. The fifth connecting structure V5 connects the first loop structure 18A of the third winding W3 to the second loop structure 18B of the second winding W2. As a result, the flow direction changes and the second loop structure 18B of the second winding W2 is traversed counterclockwise to the first connecting structure V1 at the first separation point T1. Thus, the three windings W1, W2, W3 of the receiving coil 16C are electrically connected in series.

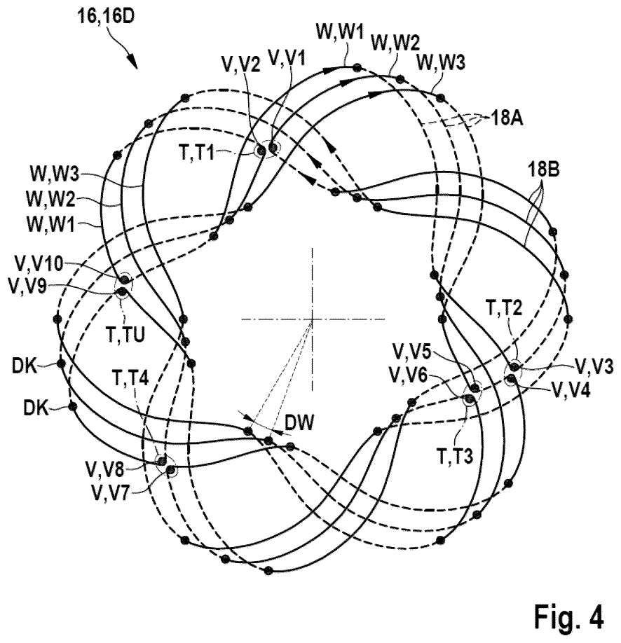

As can be further seen from FIG. 4, in contrast to the receiving coil 16C shown in FIGS. 2 and 3, the first separation points T1, T2, T3, T4 of the receiving coil 16D shown in FIG. 4 are not arranged on a common center line. Starting from a first connecting structure V1 at a first separation point T1, the first loop structure 18A of the second winding W2 of the receiving coil 16D is traversed in a clockwise direction up to a seventh connecting structure V7 at a fourth first separation point T4. The seventh connecting structure V7 connects the first loop structure 18A of the second winding W2 to the second loop structure 18B of the third winding W3. As a result, the flow direction changes and the second loop structure 18B of the third winding W3 is traversed counterclockwise up to an eighth connecting structure V8 at the fourth first separation point T4. The eighth connecting structure V8 connects the second loop structure 18B of the third winding W3 to the first loop structure 18A of the second winding W2. As a result, the flow direction changes and the first loop structure 18A of the second winding W2 is traversed in a clockwise direction up to a second connecting structure V2 at the first separation point T1. The second connecting structure V2 connects the first loop structure 18A of the second winding W2 to the second loop structure 18B of the first winding W1. As a result, the flow direction changes and the second loop structure 18B of the first winding W1 is traversed counterclockwise up to a tenth connecting structure V10 at the second separation point TU. The tenth connecting structure V10 connects the second loop structure 18B of the first winding W1 to the first loop structure 18A of the first winding W1. As a result, the flow direction changes and the first loop structure 18A of the first winding W1 is traversed in a clockwise direction up to a third connecting structure V3 at the second first separation point T2. The third connecting structure V3 connects the first loop structure 18A of the first winding W1 to the second loop structure 18B of the second winding W2. As a result, the flow direction changes and the second loop structure 18B of the second winding W2 is traversed counterclockwise up to the sixth connecting structure V6 at the third first separation point T3. The sixth connecting structure V6 connects the second loop structure 18B of the second winding W2 to the first loop structure 18A of the third winding W3. As a result, the flow direction changes and the first loop structure 18A of the third winding W3 is traversed in a clockwise direction up to the fifth connecting structure V5 at the third first separation point T3. The fifth connecting structure V5 connects the first loop structure 18A of the third winding W3 to the second loop structure 18B of the second winding W2. As a result, the flow direction changes and the second loop structure 18B of the second winding W2 is traversed counterclockwise up to the fourth connecting structure V4 at the second first separation point T2. The fourth connecting structure V4 connects the second loop structure 18B of the second winding W2 to the first loop structure 18A of the first winding W1. As a result, the flow direction changes and the first loop structure 18A of the first winding W1 is traversed in a clockwise direction up to the ninth connecting structure V9 at the second separation point TU. The ninth connecting structure V9 connects the first loop structure 18A of the first winding W1 to the second loop structure 18B of the first winding W1. As a result, the flow direction changes and the second loop structure 18B of the first winding W1 is traversed counterclockwise to the first connecting structure V1 at the first separation point T1. Thus, the three windings W1, W2, W3 of the receiving coil 16D are electrically connected in series.

As can be further seen from FIGS. 1 to 4, the connecting structures V comprise at least one through-hole plating DK. As can be further seen in particular from FIG. 3, the connecting structures V can comprise at least one connecting element 19 which connects the corresponding end of the separated loop structure 18A, 18B to the through-hole plating DK. As can be further seen from FIG. 3, at the first separation point T1, a first short connecting element 19A connects the first loop structure 18A of the first winding W1 to the corresponding through-hole plating DK. A second short connecting element 19B connects the second loop structure 18B of the second winding W2 to the corresponding through-hole plating DK. In addition, a first short connecting element 19A connects the second loop structure 18B of the second winding W2 to the corresponding through-hole plating DK. A second short connecting element 19B connects the first loop structure 18A of the first winding W1 to the corresponding through-hole plating DK. As can be further seen from FIG. 3, at the second separation point T2, a first short connecting element 19A connects the first loop structure 18A of the second winding W2 to the corresponding through-hole plating DK. A second short connecting element 19B connects the second loop structure 18B of the first winding W1 to the corresponding through-hole plating DK. In addition, a first short connecting element 19A connects the second loop structure 18B of the first winding W1 to the corresponding through-hole plating DK. A second short connecting element 19B connects the first loop structure 18A of the second winding W2 to the corresponding through-hole plating DK.

In the exemplary embodiments of the receiving coils 16 shown, the angular distance between adjacent loop structures is the same. Equal spacing enables optimum utilization of the available installation space with regard to maximizing the number of turns in order to simultaneously avoid a design rule violation. In addition, the loop structures 18A, 18B of the individual windings W of the receiving coil 16 are approximately congruent. As can be further seen from FIG. 1, the loop structures 18A, 18B of the windings W of the two receiving coils 16A, 16B are arranged grouped according to the receiving coils 16A, 16B. As cThis means that with two windings 1W1, 1W2, 2W1, 2W2 per receiving coil 16A, 16B, first three loop structures 18A, 18B of the two windings 1W1, 1W2 of the first receiving coil 16A and then two loop structures 18A, 18B of the two windings 2W1, 2W2 of the second receiving coil 16B are arranged.

What is claimed is:

1. A measured value acquisition device for an inductive sensor arrangement for detecting a rotary movement, comprising:
a circuit carrier; and
at least one receiver structure arranged on the circuit carrier, the at least one receiver structure is configured to cover a circular ring and comprises at least one receiving coil having at least two windings,
wherein a single winding of the at least one receiving coil has in each case two loop structures with periodically repeating loop sections and is formed in at least two planes of the circuit carrier,
wherein sections of individual loop structures arranged in different planes of the circuit carrier are electrically connected to each other via through-hole platings,
wherein the loop structures of the at least two windings of the at least one receiving coil are arranged offset with respect to each other by a predetermined spacing angle and are each separated at at least one separation point, which is formed within the at least one receiver structure in each case at a design-dependent intersection point of the respective loop structures arranged in different planes,
wherein at at least one first separation point, two loop structures of two different windings of the at least one receiving coil are separated, and ends of the two separated loop structures are connected to each other in pairs via a respective connecting structure, such that the two windings are electrically connected in series.

2. The measured value acquisition device according to claim 1, wherein:
two loop structures of a same winding of the at least one receiving coil are separated at at least one second separation point, and
ends of the two separated loop structures are connected to each other in pairs via the respective connecting structure, such that a respective first loop structure is connected to a respective second loop structure of the same winding.

3. The measured value acquisition device according to claim 1, wherein at the design-dependent intersection points at which the at least one separation point is formed, the corresponding loop structures have opposite flow directions.

4. The measured value acquisition device according to claim 3, wherein at least one connecting structure connects a first loop structure of one of the two windings, which has a first flow direction, to a second loop structure of another of the two windings, which has a second flow direction opposite to the first flow direction.

5. The measured value acquisition device according to claim 1, wherein a number of the at least one separation point is based on a number of the windings of the at least one receiving coil to be electrically connected in series.

6. The measured value acquisition device according to claim 1, wherein at least two first separation points, at each of which two loop structures of two different windings are separated, are arranged radially spaced apart from each other on a common center line.

7. The measured value acquisition device according to claim 1, wherein at least one connecting structure comprises at least one through-hole plating.

8. The measured value acquisition device according to claim 7, wherein the at least one connecting structure comprises at least one connecting element which connects a corresponding end of the separated loop structure to the at least one through-hole plating.

9. The measured value acquisition device according to claim 1, wherein:
the periodically repeating loop sections of the two loop structures each correspond to a complete period of a sinusoidal waveform, a rectangular waveform, a triangular waveform, or a mixed form, and
a number of the periodically repeating loop sections defines a periodicity of the at least one receiver structure.

10. An inductive sensor arrangement for detecting a rotary movement of a movable body, comprising:
at least one movable coupling device coupled to the movable body;
a measured value acquisition device according to claim 1; and
at least one exciter structure arranged on a circuit carrier of the measured value acquisition device,
wherein the at least one exciter structure is coupled to an evaluation and control unit configured to couple a periodic alternating signal into the at least one exciter structure during operation,
wherein the at least one movable coupling device is configured to influence an inductive coupling between the at least one exciter structure and at least one receiver structure of the measured value acquisition device, and
wherein the at least one evaluation and control unit is further configured to receive and evaluate signals induced in the at least one receiver structure and to determine a current position of the movable body.

11. The inductive sensor arrangement according to claim 10, wherein the at least one exciter structure comprises an exciter coil configured to enclose the receiver structure externally and/or internally.
